(19) United States
(12) Patent Application Publication
(10) Pub. No.: US 2025/0328914 A1
(43) Pub. Date: Oct. 23, 2025

(54) CLASSIFYING CUSTOMER'S INTENT USING LARGE LANGUAGE MODELS (LLMS)

(71) Applicant: T-Mobile USA, Inc., Bellevue, WA (US)

(72) Inventor: Jan Olav Opedal, Ellensburg, WA (US)

(21) Appl. No.: 18/643,884

(22) Filed: Apr. 23, 2024

(51) Int. Cl. G06Q 30/015; G06F 40/205; G06F 40/30; G06V 30/19; G10L 15/26

(52) U.S. Cl. CPC G06Q 30/015; G06F 40/205; G06F 40/30; G06V 30/19173; G10L 15/26

(57) ABSTRACT

A system for classifying customer communications based on customer intent receives a communication from a customer during a communication session. The communication can include natural language. The system can create an embedding vector based on the natural language of the communication. The first embedding vector can include a numerical representation of natural language extracted from the communication. The system can compare the embedding vector to multiple embedding vectors associated with intent classifications corresponding to a prediction of a type of assistance available for customers. The multiple embedding vectors can be created based on a model that is configured to identify customer intent. The system can identify which intent classification of the multiple intent classifications is associated with the embedding vector based on the comparison. The system can redirect the communication session to a sub-unit of the telecommunications network service provider based on the identified intent classification.

### BACKGROUND

Customer service sessions involve interactions between a customer and a company or an organization during which the customer seeks assistance, information, or a solution to an occurred problem that is associated with a product or a service provided by the company or the organization. Traditionally, customer service sessions can include telephone conversations between the customer and a customer service representative of the company or organization. More recently, customer service sessions can include chat sessions between the customer and a customer service representative. In some instances, customer service sessions include chatbot sessions in which the customer interacts with an artificial intelligence-(AI) based software program configured to simulate a conversation with the customer. Overall, customer service sessions include either written or oral communication involving natural language. Companies and organizations have a desire to improve customer service sessions, for example, to reduce time required for the sessions or to increase the accuracy of the assistance provided in order to increase customer satisfaction.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates a customer service system that can implement aspects of the present technology.

FIG. 3 is a block diagram that illustrates models for creating embedding vectors for classifying communications.

FIG. 4 is a block diagram that illustrates a model for classifying communications based on intent.

FIG. 5 is a flow diagram that illustrates processes for classifying customer communications.

FIG. 6 is a block diagram that illustrates an example of a computer system in which at least some operations described herein can be implemented.

FIG. 7 is a block diagram of an example transformer 712 that can implement aspects of the present technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for methods and systems for improving accuracy and efficiency of communications during customer service sessions. Specifically, the disclosed methods and systems are directed to identifying customer's intent for reaching out to a company or an organization. The intent can include the type of problem the customer is trying to solve, a type of information the customer needs, or a type of service the customer would likely benefit from. The intent can be identified by using artificial intelligence-based models that classify a communication session to an intent classification based on the natural language expressed during a current and/or historical communication session. In particular, the present technology can classify the intent in real time such that the customer's intent is identified while the customer is interacting with a customer service representative or a chatbot and the intent can be used to assist the customer during the interaction.

In particular, the present technology uses a vector model and a vector repository that are created based on a combination of AI-based models (e.g., large language models) to classify customer's intent. The vector model can be used for a real-time classification of customer's intent during a communication session (e.g., a telephone call or a chatbot session). The described technology is beneficial compared to using, for example, an LLM model to classify the customer's intent. While an LLM is well-equipped for classifying intents of a natural language conversation, it is not feasible to process conversations in real-time through the LLM because LLM is not fast enough. For example, LLM-based processing would not be fast enough for a customer service representative, automated voice response system, or chatbot software to make use of that classification during a telephone call with a customer. LLM processing is also expensive compared to processing of a more simple vector model.

In one example, a computer-implemented method for classifying customer communications with a telecommunications network service provider based on customer intent includes receiving a communication from a customer associated with the telecommunications network by a server system associated with the telecommunications network service provider. The communication can be received during a communication session. The communication can include natural language. The communication session can be a phone call between the customer and a customer service representative associated with the telecommunications network service provider. The method can include creating a first embedding vector based on the natural language of the communication by the server system. The first embedding vector can include a numerical representation of natural language (e.g., natural language data) extracted from the communication. The method can include comparing the first embedding vector to multiple embedding vectors stored in a vector database associated with the server system by the server system. Each of the multiple embedding vectors can be associated with an intent classification of multiple intent classifications. The multiple intent classifications can correspond to a prediction of a type of assistance available for customers. The multiple embedding vectors can be created based on a model that is configured to identify customer communication intent. The model can be trained based on a set of interactive voice response (IVR) transcripts of historical customer communications. The method can include identifying which intent classification of the multiple intent classifications is associated with the first embedding vector based on the comparison. The identification can be performed in real time during the communication session. The method can include redirecting the phone call to a sub-unit of the telecommunications network service provider based on the identified intent classification.

In another example, a computer-implemented method for classifying customer communications with a telecommunications network service provider based on customer intent includes receiving a communication from a customer. The customer is associated with the telecommunications network. The communication is received by a server system associated with the telecommunications network service provider. The communication is received during a chatbot session. The communication includes natural language. The chatbot session is between the customer and a chatbot software application configured to generate natural language in response to communications received from customers. The method can include creating a first embedding vector based on the natural language of the communication by the server system. The first embedding vector can include a numerical representation of natural language extracted from the communication. The method can include comparing the first embedding vector to multiple embedding vectors stored in a vector database associated with the server system by the server system. Each of the multiple embedding vectors can be associated with an intent classification of multiple intent classifications. The multiple embedding vectors are created based on a model that is configured to identify customer communication intent. The method can include identifying which intent classification of the multiple intent classifications is associated with the first embedding vector based on the comparison. The identification can be performed in real time during the communication session. The method can include generating a response to the received communication based on the identified intent classification by the chatbot software application.

In yet another example, a system for classifying customer communications with a telecommunications network service provider based on customer intent receives a communication from a customer associated with the telecommunications network during a communication session. The communication can include natural language. The communication session is between the customer and a customer service representative associated with the telecommunications network service provider. The system can create a first embedding vector based on the natural language of the communication. The first embedding vector can include a numerical representation of natural language extracted from the communication. The system can compare the first embedding vector to multiple embedding vectors stored in a vector database associated with the server system. Each of the multiple embedding vectors can be associated with an intent classification of multiple intent classifications corresponding to a prediction of a type of assistance available for customers. The multiple embedding vectors can be created based on a model that is configured to identify customer communication intent. The system can identify based on the comparison which intent classification of the multiple intent classifications is associated with the first embedding vector. The system can redirect the communication session to a sub-unit of the telecommunications network service provider based on the identified intent classification.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

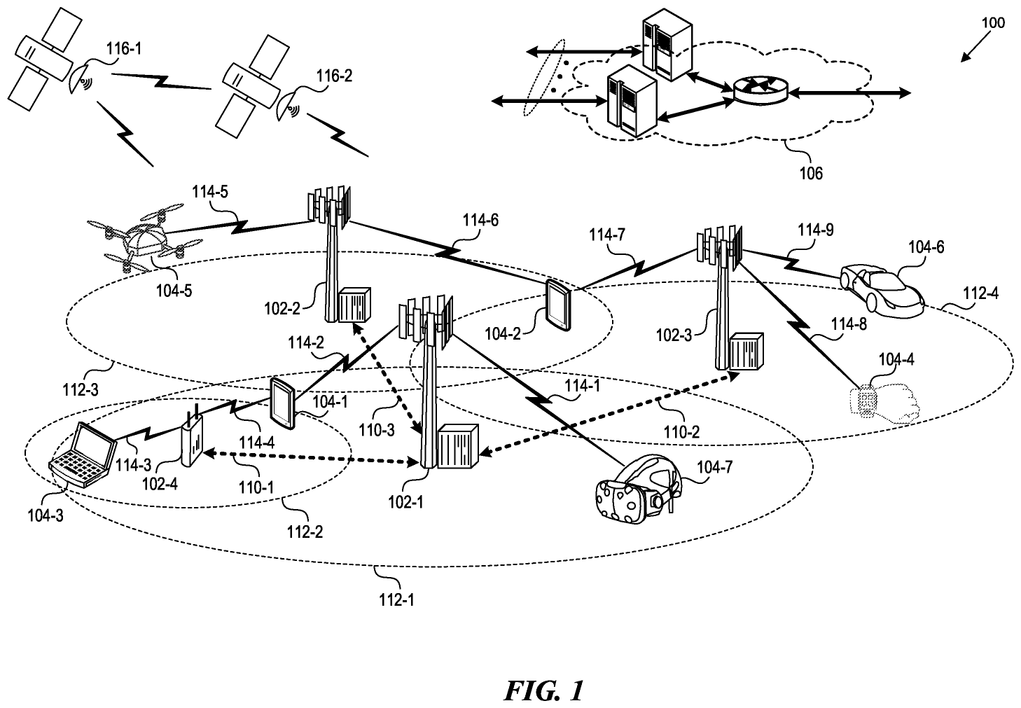

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the system 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provides data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or Time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service requirements and multi-terabits per second data transmission in the 6G and beyond era, such as terabit-per-second backhaul systems, ultrahigh-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged Wi-Fi and Core architecture to increase and improve indoor coverage.

### Classifying Customer's Intent

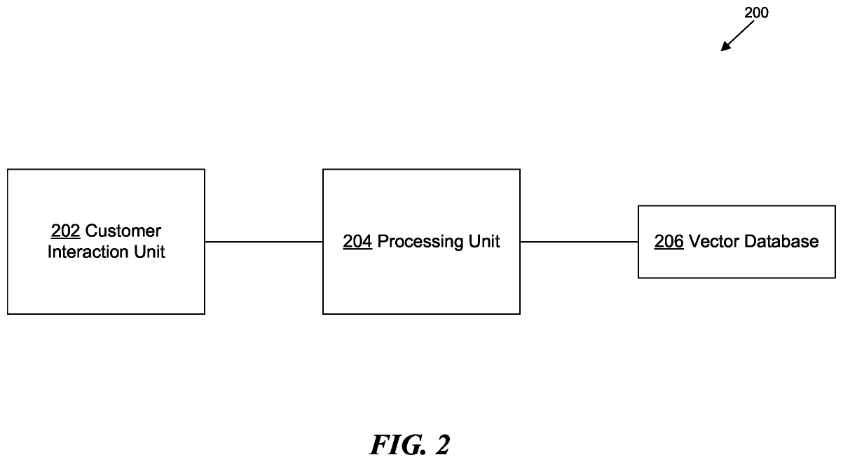

FIG. 2 is a block diagram that illustrates a customer service system 200 that can implement aspects of the present technology. The customer service system 200 includes a customer interaction unit 202, a processing unit 204, and a vector database 206. The customer service system 200 is configured to receive a customer communication during a communication session and process the customer communication to classify the communication based on the customer's intent.

The customer interaction unit 202 is configured to receive a communication from a customer as part of a communication session. The communication can be in a form of a written or oral language and includes natural language. The communication is provided by the customer during a communication session involving the customer and a customer representative or a chatbot software. The communication session can include a conversation (e.g., a phone call or a video call) and/or a chat (e.g., exchange of written messages) between the customer and a customer service representative. The communications can also be a conversation or a chat between the customer and a chatbot software. The customer interaction unit 202 can include the chatbot software or be in communication with a separate computer system that includes the chatbot software. In some implementations, the chatbot software is configured to tailor its communication style based on a customer's sentiment. For example, the chatbot software can detect whether the customer has a friendly tone or an angry tone and adjust the communication style accordingly. The customer interaction unit 202 transmits the communication to the processing unit 204.

In some implementations, the processing unit 204 uses natural language processing (NPL) to extract natural language from the communication. For example, when the communication is in an oral form, the processing unit 204 uses NPL to convert the oral communication into a written form (e.g., as a string of text). The processing unit 204 is configured to process the communication to create an embedding vector that includes a numerical representation of the natural language extracted from the communication. The processing unit 204 is then configured to compare the embedding vector to multiple embedding vectors, each of which is associated with an intent classification. The multiple embedding vectors can be stored at the vector database 206. For example, the processing unit 204 can retrieve vector data from the vector database 206 that includes the multiple embedding vectors. The processing unit 204 can identify an intent classification for the embedding vector representative of the communication while the communication session between the customer and the customer service representative and/or chatbot is ongoing (e.g., in real time or near real time).

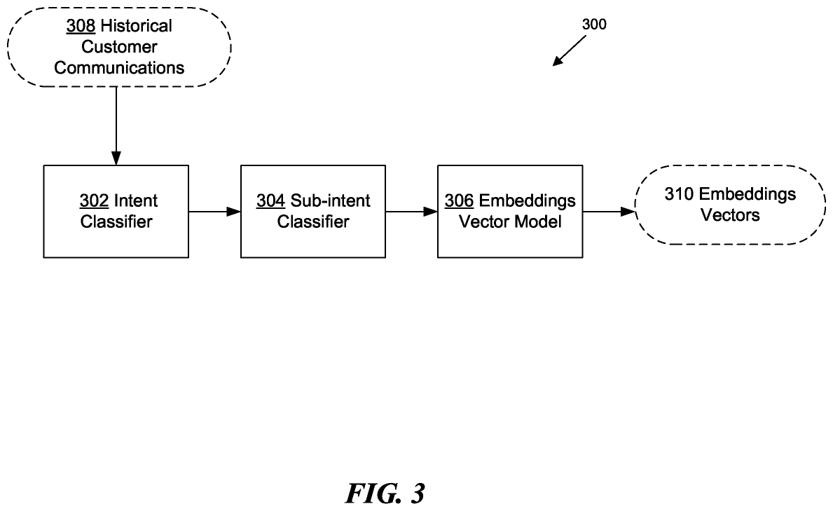

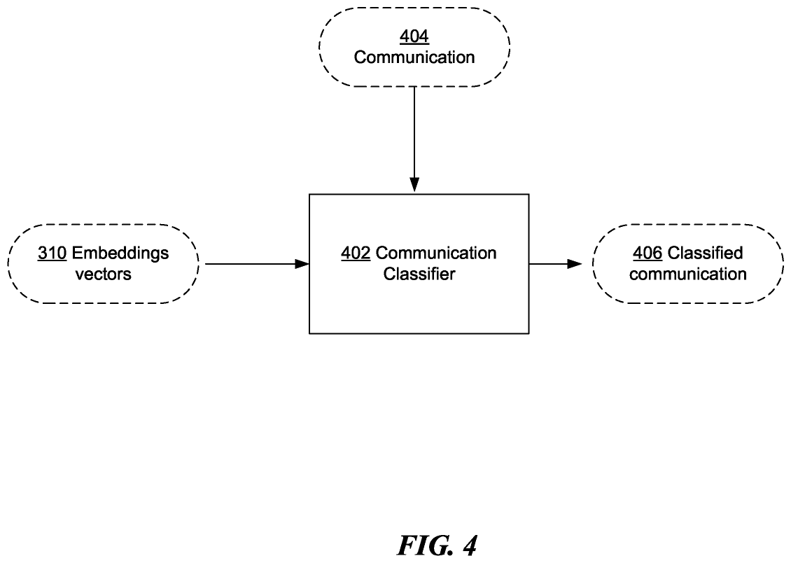

The processing unit 204 can include a communication classifier model (e.g., a communication classifier 402 in FIG. 4) configured to create an embedding vector from a communication received from the customer interaction unit based on a vector-generating model. The communication classifier model is also configured to classify the communication by comparing the generated embedding vector to the embedding vectors in the vector database 206. The communication classifier can be trained based on the models described with respect to FIGS. 3 and 4. Overall, the models described with respect to FIGS. 3 and 4 represent a combination of machine learning models (e.g., LLM, NPL, and vector models). For example, while an LLM is well-equipped for classifying intents and sub-intents in a natural language conversation, it is not feasible to process conversations in real-time through the LLM because LLM is not fast enough. For example, LLM-based processing would not be fast enough for a customer service representative, automated voice response system, or chatbot software to make use of that classification during a conversation with a customer. Using embedding vectors instead of LLM for classifying the customers' intent can reduce latency. The described communication classifier can also have improved answers compared to using LLM alone (e.g., with respect to identifying the tone of a communication received from a customer). LLM processing is also a costly option for many applications and therefore LLM processing for applications such as customer interaction is not feasible. Therefore, it is more beneficial to use a vector model in the processing unit 204, as described. The present methods, however, describe the use of LLM to generate the intent classifications and to build a repository of vectors (e.g., the vectors in the vector database 206) so that these vectors can be used in real-time rather than new LLM processing. The present methods can also be used for analytics, such as identifying similar customers and customer complaints and intents to further train the models described in FIGS. 3 and 4 below. For example, it is common to use taxonomies (ontologies) to classify customer intents. Such taxonomies tend to stay fixed for a long period of time. The taxonomy can be updated when there is a shift in what the customers are asking for. For example, when customers purchase a newer model of a smart device, the taxonomy can be shifted to relate to the newer model.

FIG. 3 is a block diagram that illustrates models 300 for creating embedding vectors for classifying communications. The models 300 include an intent classifier 302, a sub-intent classifier 304, and an embedding vector model 306. FIG. 3 also illustrates historical customer communications 308 as an input and embedding vectors 310 (e.g., embedding vector data) as an output of the processes performed by the models 300. The models 300 are for generating the embedding vectors 310 (e.g., stored in the vector database) which can then be used by customer service system 200 to classify the communication based on the customer's intent, as described with respect to FIG. 2.

The intent classifier 302 is configured to receive the historical customer communications 308 as an input and generate a first training set that includes the historical customer communications associated with an intent extracted from the historical customer communication. The historical customer communications 308 can include historical interactive voice response (IVR) transcripts (e.g., a set of IVR transcripts that is relevant for the purpose of identifying a customer's intent). IVR refers to a technology for interactions between a human and a computer system by using voice inputs and/or other inputs (e.g., keypad inputs on a phone or a computer device). IVRs are, for example, used for routing incoming customer calls within an organization to an appropriate department of the organization. The historical customer communications 308 can include a written text corresponding to the communications between the customers and an IVR system. The historical customer communications 308 can be generated, for example, by speech-to-text conversion techniques based on audio data collected during historical customer interactions.

As an example, an IVR transcript can include interaction between a customer who is calling in to get assistance from an organization and an IVR system associated with the organization. The customer's communications are responded to by pre-recorded questions and instructions by the IVR technology that attempt to identify the customer's need for assistance related to and thereby identifying a department within the organization. The pre-recorded IVR questions and instructions can include, for example, a request to say “billing” when the customer has a question related to their invoice, or a request to “press 1 for billing department.”

The historical transcripts can additionally or alternatively include transcripts other than IVR transcripts, such as chat transcripts or transcripts generated based on a telephone or video conversation between two or more humans.

In some implementations, the intent classifier 302 can pre-process the historical customer communications 308. The pre-processing can include filtering the terms of the communication based on their salience or importance. For example, the pre-processing can include excluding words that are known to have no effect on the intent of the communication (e.g., greetings, customer identifying information such as name or phone number). The pre-processing can also include providing weights on words that are known to have effect on the intent of the communication. For example, terms associated with the intent classification “billing” can include “bill,” “invoice,” “overcharge,” etc.

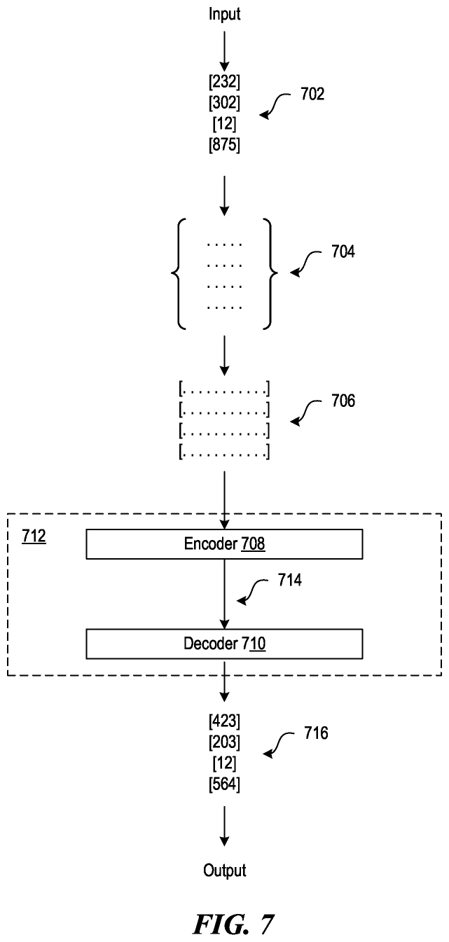

The intent classifier 302 can process the IVR transcripts by a machine learning (ML) model such as a large language model (LLM). Principles of an example LLM are described with respect to FIG. 7. The intent classifier 302 can use engineered prompts that include instructions for the LLM to identify an intent classification (e.g., a theme) for each of the IVR transcripts. In some embodiments, the intent classifications are predefined based on different departments of the organization. For example, the different departments of a telecommunications network provider can include a billings department, a marketing department, customer account management (e.g., subscription management), and network operations. For the telecommunications network provider, the intent classifications can thereby include billing, account management, marketing, and network operation. Since some conversations may address more than one of these intents, the intent classifier 302 can assign multiple intent classifications to a transcript or can divide a transcript into two or more portions that are each assigned a respective classification. The intent classifier 302 therefore creates a first training set that includes a set of IVR transcripts or portions of IVR transcripts with each of the transcripts associated with an intent classifier.

The sub-intent classifier 304 is configured to identify intent sub-classifications (e.g., topics) for the set of IVR transcripts of the first training set. For example, an IVR transcript associated with a particular intent classification can be further associated with one or more sub-classifications. Each intent classification can be associated with multiple sub-classifications. For example, an intent classification for account management for the telecommunications network can be associated with intent sub-classifications of purchasing a new subscription, upgrading an existing subscription, adding or removing a wireless device from a subscription (e.g., from a family plan), or updating account information (e.g., changing an address or an associated payment information). The sub-intent classifier 304 can thereby create a second training set that includes the set of historical transcripts or portions of historical transcripts, with each of the transcripts associated with the intent classifier (e.g., from the intent classifier 302) and one or more sub-intent classifications.

In some implementations, the sub-intent classifier 304 can include an LLM model that uses engineered prompts to identify the sub-intent classifications for each of the IVR transcripts in the first training set. The set of sub-intent classifications applied to the historical transcripts can be classifications that are selected by the LLM as the LLM processes each transcript. Alternatively, the LLM can be prompted to apply a sub-intent classification to each transcript that is selected from a predefined list of sub-intent classifications. The sub-intent classifier 304 can operate similar to as described above for the intent classifier 302 based on the LLM principles described with respect to FIG. 7.

In some implementations, the sub-intent classifier 304 includes one or more natural language processing (NLP) models to identify the sub-intent classifications for each of the IVR transcripts in the first training set. An NLP model is a computational linguistics model based on AI that can extract natural language and understand and interpret natural language in a useful and meaningful manner. NLP models can include tokenization (e.g., breaking down natural language communication to smaller units such as words and sentences), part-of-speech (POS) tagging (e.g., associating words as nouns, verbs, adjectives, etc.), analyzing grammatical structures to understand the relationships between words in a sentence (parsing), and/or semantic analysis (e.g., interpreting text beyond its literal meaning). The NLP model can also be trained to classify text (e.g., the IVR transcripts) into predefined categories or topics based on the content of the text. The NLP can be trained, for example, by ML techniques known in the art such as Naive Bayes, Support Vector Machines (SVM), logistic regression, and/or deep learning models.

The second training set created by the sub-intent classifier 304 can include the set of historical transcripts or portions of historical transcripts associated with the intent classification (e.g., based on the first training set) and one or more sub-intent classifications. The embedding vector model 306 can receive the second training set and create embedding vectors 310 from the second training set. An embedding vector refers to a numerical representation of natural language extracted from text. Here, each embedding vector of the embedding vectors 310 is a numerical representation of an IVR transcript associated with an intent classification and one or more sub-intent classifications. The embedding vector model 306 can be a vector model for creating vector representations from text.

A vector model can transform text into a fixed-size numerical vector that can capture the semantic and contextual information (including the intent classification and the sub-intent classifications of the second training set) of the text the vector represents. A vector model can include a word embedding model (e.g., Word2Vec, FastText, or GloVe), Doc2Vec, Term Frequency-Inverse Document Frequency (TF-IDF), Bag-of-Words (BoW), or transformer-based models. The word embedding models can create vector representations for individual words that can be averaged or concatenated to generate vector representations for sentences or text documents. Doc2Vec is an extension of Word2Vec, which can create fixed-sized vector representations for documents or sentences. Doc2Vec can capture aspects of sentence and document semantics. TF-IDF can compute numerical representations for documents by emphasizing terms that are important (frequent) within a specific document and downweighing terms that are common across documents generally. BoW can compute vectors representing documents where each dimension of a vector corresponds to a unique term and the value of the vector indicates the frequency in the document. The transformer-based models (e.g., the Bidirectional Encoder Representations from Transformers (BERT) model, the Transformer-XL model, and the Generative Pre-trained Transformer (GPT) models) are described with respect to FIG. 7.

In some implementations, the embedding vectors 310 are stored to the vector database 206 described with respect to FIG. 2. When a new customer communication is received from the customer interaction unit 202, the processing unit 204 can compare an embedding vector created based on the new communication with the embedding vectors 310. Based on the comparison, the processing unit 204 can associate the new communication with an intent classification and one or more sub-intent classifications without needing to process the new communication through the LLM to assign these classifications.

FIG. 4 is a block diagram that illustrates a communication classifier 402 for classifying communications based on intent. The communication classifier 402 can be part of the processing unit 204 described with respect to FIG. 2. The communication classifier 402 is configured to create an embedding vector from a communication 404 based on a vector generating model and classify the communication 404 by comparing the generated embedding vector to the embedding vectors 310 described with respect to FIG. 3. The classifying can include identifying an embedding vector from the embedding vectors 310 that has highest similarity to the embedding vector created based on the communication 404. After processing the communication 404, communication classifier 402 is configured to output a classified communication 406. The classified communication 406 can include the intent classification and/or one or more sub-intent classifications, as described with respect to FIG. 3.

The communication 404 can correspond to a communication received by the processing unit 204 from the customer interaction unit 202, as described with respect to FIG. 2. For example, the communication 404 includes written or spoken natural language received as an input from a customer as part of a communication session. The communication session can be between the customer and a customer representative or a chatbot software. The communication session can include conversation (e.g., a phone call or a video call) and/or a chat (e.g., exchange of written messages) between the customer and a customer service representative or a conversation and/or a chat between the customer and a chatbot software.

The communication classifier 402 can include an embedding vector model, which is trained by the embedding vectors 310 to generate an embedding vector based on the communication 404. In some implementations, the embedding vector model of the communication classifier 402 can be trained with vector models such as those described with respect to embedding vector model 306. In some embodiments, the communication classifier 402 is trained with a logistic regression model, which is a linear ML approach for creating embedding vectors based on text representation. Specifically, logistic regression can define a dataset (e.g., the communication 404) as a set of independent features (variables) represented as vectors. Computation with logistic regression can be very fast. Generative AI and deep learning can be used to classify datasets in batches, and logistic regression can be used for fast computation. In some implementations, the communication classifier 402 can be trained with other fast algorithms such as cosine similarity, Euclidian distance, K-Nearest Neighbor (KNN), Approximate KNN, dot product, and/or Jaccard distance.

The created embedding vector includes a numerical representation of the natural language extracted from the communication 404. In some embodiments, the communication classifier 402 is also configured to pre-process the communication 404 before creating the embedding vector. The pre-processing can include, for example, converting a spoken format communication into a written text communication (e.g., speech-to-text conversion techniques). The pre-processing can also include filtering the terms of the communication based on their salience, as described with respect to the intent classifier 302.

Subsequent to creating an embedding vector from the communication 404, the communication classifier is configured to compare the created embedding vector to the embedding vectors 310 to associate the communication with an intent classification and one or more sub-intent classifications. This operation by the communication classifier 402 is optimized for speed in order to be able to create the embedding vector based on the communication 404 and to classify the embedding vector during the communication session that is ongoing between the customer and a customer service representative and/or chatbot. The process performed by the communication classifier 402 can be performed in real time or in near real time.

In some implementations, comparing the embedding vector created based on the communication 404 to the embedding vectors 310 includes performing an elasticsearch on a database including the embedding vectors 310. Elasticsearch can refer to a distributed, open-source search and analytics engine (e.g., using Apache Lucene search engine). Elasticsearch can be used in real-time searches and analysis of text as well as vector representations. The communication classifier 402 can apply elasticsearch for searching the database including the embedding vectors 310 to identify vectors matching (e.g., matching within a threshold distance) with the embedding vector created based on the communication 404. In some embodiments, the communication classifier 402 can apply lookup techniques for searching the database including the embedding vectors 310 to identify vectors matching (e.g., matching within a threshold distance) with the embedding vector created based on the communication 404.

The communication classifier 402 can identify an embedding vector from the embedding vectors 310 having the highest similarity to the embedding vector created based on the communication 404 by vector distance (also known as vector similarity or distance metric). The vector distance can be computed as a distance metric known in the art, such as cosine similarity, Euclidean distance, Manhattan distance, Jaccard similarity, or Hamming distance. Based on the vector distance, the communication classifier can predict that the embedding vector created based on the communication 404 has the same intent and the same one or more sub-intent classifications as an embedding vector of the embedding vectors 310 having the shortest distance to the created embedding vector. The communication classifier 402 can output the classified embedding vector as classified communication 406.

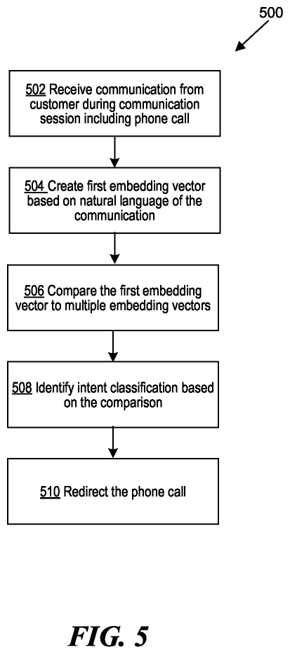

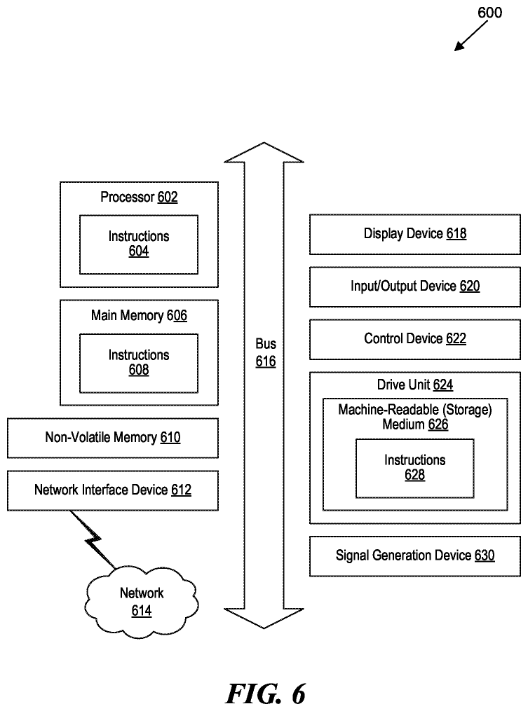

FIG. 5 is a flow diagram that illustrates processes 500 for classifying customer communications. The processes 500 can be performed by a system (e.g., the system 200 in FIG. 2) associated with a wireless network (e.g., the wireless network 100 in FIG. 1). The server system can be associated with a telecommunications network and include at least one hardware processor and at least one non-transitory memory storing instructions (e.g., a computer system 600 described with respect to FIG. 6). When the instructions are executed by the at least one hardware processor, the server system performs the processes 500.

The processes 500 are directed for using machine learning (ML) models for predicting a customer's intent during a customer communication session (e.g., a phone call or a chatbot session). The prediction is performed in real time or near real time so that the prediction can be used to assist the customer during the communication session. Such a fast processing of the customer communication is facilitated a communication classifier (e.g., the communication classifier 402) including a model trained to generate an embedding vector from the customer communication and comparing the embedding vector to multiple embedding vectors associated with intents and sub-intents. Such comparison can be done in real-time because of the fast processing time of vector comparisons. For example, a customer's intent during a phone call can be predicted based on what the customer is saying, and the phone can be redirected to an appropriate department for more efficient communication and assistance. As another example, a customer's intent during a chatbot conversation can be predicted based on what the customer is saying and the chatbot software can generate a response based on the customer's intent, rather than only based on the customer's last input.

At 502, a system can receive a communication from a customer associated with the telecommunications network by a server system associated with the telecommunications network service provider. For example, processing unit 204 in FIG. 2 receives a communication (e.g., the communication 404 in FIG. 4) from the customer interaction unit 202. The processing unit 204 includes the communication classifier 402 in FIG. 4.

The communication can be received during a communication session. The communication can include natural language. In some implementations, the system can create a transcript of the communication including the natural language by NLP. The communication session can be a phone call between the customer and the telecommunications network service provider. The communication can be received by a customer representative associated with the customer interaction unit 202 or by an automated response system (e.g., an IVR system) associated with the customer interaction unit 202. The communication can be recorded (e.g., a phone call is recorded, and the recording is processed by the processing unit 204).

In some implementations, the chatbot session is between the customer and a chatbot software application configured to generate natural language in response to communications received from customers. For example, a chatbot software application is part of or in communication with the customer interaction unit 202. The chatbot session can be a phone call or a chat (e.g., chat including exchanged messages).

At 504, the system (e.g., the communication classifier 402 in FIG. 4) can create a first embedding vector based on the natural language of the communication (e.g., the communication 404) by the server system. The first embedding vector can include a numerical representation of natural language extracted from the communication. In some implementations, creating the first embedding vector includes parsing the natural language of the communication into a sequence of text segments and converting the sequence of text segments into the numerical representation of the natural language used for creating the first embedding vector.

At 506, the system can compare the first embedding vector to multiple embedding vectors stored (e.g., the embedding vectors 310 in FIGS. 3 and 4) in a vector database associated with the server system by the server system. Each of the multiple embedding vectors can be associated with an intent classification of multiple intent classifications. The multiple intent classifications correspond to a prediction of a type of assistance available for customers. The multiple embedding vectors can be created based on a model that is configured to identify customer communication intent (e.g., the models 300 including the intent classifier 302). The model can be trained based on a set of interactive voice response (IVR) transcripts (e.g., the historical customer communications 308) of historical customer communications.

In some implementations, the model (e.g., the intent classifier 302 in FIG. 3) is created based on the set of the IVR transcripts of historical customer communications by creating a first training set. The first training set can be created by inputting the set of the IVR transcripts into a first model. The first model can associate each of the IVR transcripts in the set of IVR transcripts with a respective intent classification of the multiple intent classifications to create the first training set. The first training set can include the set of the IVR transcripts. Each of the IVR transcripts can be associated with the respective intent classification.

In some implementations, creating the model based on the set of the IVR transcripts of historical customer communications further includes creating a second training set. The second training set can be created by inputting the first training set to a second model (e.g., the sub-intent classifier 304 in FIG. 3). For example, the intent classifier 302 inputs the first training set to the sub-intent classifier 304. One or more sub-classifications for each of the IVR transcripts in the first training set can be extracted by the second model. The second model can be associated with each of the IVR transcripts in the first training set with the one or more sub-classifications to create the second training set. The multiple embedding vectors can be created from the second training set by a third model (e.g., the embedding vector model 306 in FIG. 3). For example, the sub-intent classifier 304 inputs the second training set to the embedding vector model 306. The embedding vector model 306 creates embedding vectors 310 and stores them to an embedding vector database.

In some implementations, the first embedding vector is created based on a fourth model. For example, the first embedding vector is created by the communication classifier 402 including a vector model, as described with respect to FIG. 4. The fourth model can be trained by inputting to the fourth model the multiple embedding vectors (e.g., embedding vectors 310) created from the second training set. Each of the multiple embedding vectors can include a numerical representation of natural language extracted from the IVR transcripts and associated intent classification and one or more associated sub-classifications. The fourth model can be trained to create embedding vectors based on natural language input.

In some implementations, the communication classifier 402 performs a search (e.g., an elastic search) or a lookup at a database storing the embedding vectors 310 to identify embedding vectors that are a match with the first embedding vector. A match can refer to having a vector distance between the first embedding vector and an embedding vector of the embedding vectors 310 that is within a pre-defined threshold distance. In some implementations, comparing the first embedding vector to the multiple embedding vectors stored in the vector database includes determining cosine distances between the first embedding vector and the multiple embedding vectors. The cosine distances represent similarities between the first embedding vector and the multiple embedding vectors.

At 508, the system can identify which intent classification of the multiple intent classifications is associated with the first embedding vector based on the comparison. The system can also identify which sub-intent classification is associated with the first embedding vector based on the comparison. The identification can be performed in real time during the communication session. In some implementations, the intent classifications include an intent related to network operation, an intent related to marketing, an intent related to billing, or an intent related to customer accounts. The intent classifications represent, for example, the most common departments that the customers interact with within a telecommunications network service provider. Each intent classification can include two or more sub-classifications. The sub-classifications can represent topics (e.g., the most common topics) within each of the departments that the customers need assistance with or request information about. Each of the multiple embedding vectors can be further associated with a sub-classification of the two or more sub-classifications. The system can identify (e.g., by the sub-intent classifier 304) which intent sub-classification of the multiple intent sub-classifications is associated with the first embedding vector.

At 510, the system can redirect the phone call to a sub-unit (e.g., a department) of the telecommunications network service provider based on the identified intent classification. In some implementations, the system associates the customer with the sub-unit of the telecommunications network service provider based on the identified intent classification. The sub-unit of the telecommunications network service provider can be associated with network operation, marketing, billing, or customer account management. The real-time intent identification can reduce the time for the customer to get in contact with the correct sub-unit and the time required for the communication session.

In some embodiments, when the communication session is a chatbot session, the system can generate a response to the received communication based on the identified intent classification. The response can be generated by the chatbot software application operated on the customer interaction unit 202 or on a separate computer system that is in communication with the customer interaction unit 202. For example, the processing unit 204 can communicate the identified intent and one or more identified sub-intents to the chatbot software application. The chatbot software application can generate a response to the customer during the communication session based on the identified intent and the one or more sub-intents.

### Computer System

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, video display device 618, an input/output device 620, a control device 622 (e.g., keyboard and pointing device), a drive unit 624 that includes a storage medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementation, the computer system 600 can be an embedded computer system, a system-on-chip (SOC), a single-board computer system (SBC) or a distributed system such as a mesh of computer systems or include one or more cloud components in one or more networks. Where appropriate, one or more computer systems 600 can perform operations in real-time, near real-time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable (storage) medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed, and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly-available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 7 is a block diagram of an example transformer 712. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 712 includes an encoder 708 (which can comprise one or more encoder layers/blocks connected in series) and a decoder 710 (which can comprise one or more decoder layers/blocks connected in series). Generally, the encoder 708 and the decoder 710 each include a plurality of neural network layers, at least one of which can be a self-attention layer. The parameters of the neural network layers can be referred to as the parameters of the language model.

The transformer 712 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 712 is trained to perform certain functions on other input formats than natural language input. For example, the input can include objects, images, audio content, or video content, or a combination thereof.

The transformer 712 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 7 illustrates an example of how the transformer 712 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 7, a short sequence of tokens 702 corresponding to the input text is illustrated as input to the transformer 712. Tokenization of the text sequence into the tokens 702 can be performed by some pre-processing tokenization module such as, for example, a byte-pair encoding tokenizer (the “pre” referring to the tokenization occurring prior to the processing of the tokenized input by the LLM), which is not shown in FIG. 7 for simplicity. In general, the token sequence that is inputted to the transformer 712 can be of any length up to a maximum length defined based on the dimensions of the transformer 712. Each token 702 in the token sequence is converted into an embedding vector 706 (also referred to simply as an embedding 706). An embedding 706 is a learned numerical representation (such as, for example, a vector) of a token that captures some semantic meaning of the text segment represented by the token 702. The embedding 706 represents the text segment corresponding to the token 702 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 706 corresponding to the “write” token will be closer to another embedding corresponding to the “jot down” token in the vector space as compared to the distance between the embedding 706 corresponding to the “write” token and another embedding corresponding to the “summary” token.

The vector space can be defined by the dimensions and values of the embedding vectors. Various techniques can be used to convert a token 702 to an embedding 706. For example, another trained ML model can be used to convert the token 702 into an embedding 706. In particular, another trained ML model can be used to convert the token 702 into an embedding 706 in a way that encodes additional information into the embedding 706 (e.g., a trained ML model can encode positional information about the position of the token 702 in the text sequence into the embedding 706). In some examples, the numerical value of the token 702 can be used to look up the corresponding embedding in an embedding matrix 704 (which can be learned during training of the transformer 712).

The generated embeddings 706 are input into the encoder 708. The encoder 708 serves to encode the embeddings 706 into feature vectors 714 that represent the latent features of the embeddings 706. The encoder 708 can encode positional information (i.e., information about the sequence of the input) in the feature vectors 714. The feature vectors 714 can have very high dimensionality (e.g., on the order of thousands or tens of thousands), with each element in a feature vector 714 corresponding to a respective feature. The numerical weight of each element in a feature vector 714 represents the importance of the corresponding feature. The space of all possible feature vectors 714 that can be generated by the encoder 708 can be referred to as the latent space or feature space.

Conceptually, the decoder 710 is designed to map the features represented by the feature vectors 714 into meaningful output, which can depend on the task that was assigned to the transformer 712. For example, if the transformer 712 is used for a translation task, the decoder 710 can map the feature vectors 714 into text output in a target language different from the language of the original tokens 702. Generally, in a generative language model, the decoder 710 serves to decode the feature vectors 714 into a sequence of tokens. The decoder 710 can generate output tokens 716 one by one. Each output token 716 can be fed back as input to the decoder 710 in order to generate the next output token 716. By feeding back the generated output and applying self-attention, the decoder 710 is able to generate a sequence of output tokens 716 that has sequential meaning (e.g., the resulting output text sequence is understandable as a sentence and obeys grammatical rules). The decoder 710 can generate output tokens 716 until a special [EOT] token (indicating the end of the text) is generated. The resulting sequence of output tokens 716 can then be converted to a text sequence in post-processing. For example, each output token 716 can be an integer number that corresponds to a vocabulary index. By looking up the text segment using the vocabulary index, the text segment corresponding to each output token 716 can be retrieved, the text segments can be concatenated together, and the final output text sequence can be obtained.

In some examples, the input provided to the transformer 712 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A computer-implemented method for classifying customer communications with a telecommunications network service provider based on customer intent, the method comprising:
receiving during a communication session, at a server system associated with the telecommunications network service provider, a communication from a customer,
and
wherein the communication session is a phone call between the customer and the telecommunications network service provider;
creating, by the server system, a first embedding vector representing a numerical representation of natural language extracted from the communication;
comparing, by the server system, the first embedding vector to multiple embedding vectors stored in a vector database associated with the server system,
wherein each of the multiple embedding vectors is associated with an intent classification of multiple intent classifications,
wherein the multiple intent classifications correspond to a prediction of a type of assistance available for customers,
wherein the multiple embedding vectors are created based on a model that is configured to identify customer communication intents, and
wherein the model is trained based on a set of interactive voice response (IVR) transcripts of historical customer communications;
identifying, based on the comparison, which intent classification of the multiple intent classifications is associated with the first embedding vector,
wherein the identification is performed in real-time during the communication session; and
redirecting the phone call to a sub-unit of the telecommunications network service provider based on the identified intent classification.

2. The method of claim 1, further comprising:
associating, by the server system, the customer with the sub-unit of the telecommunications network service provider based on the identified intent classification,
wherein the sub-unit of the telecommunications network service provider is associated with network operation, marketing, billing, or customer account management.

3. The method of claim 1, further comprising creating the model based on the set of the IVR transcripts of historical customer communications by:
creating a first training set by:
inputting the set of the IVR transcripts into a first model; and
causing the first model to associate each of the IVR transcripts in the set of IVR transcripts with a respective intent classification of the multiple intent classifications to create the first training set,
wherein the first training set includes the set of the IVR transcripts, each of the IVR transcripts associated with the respective intent classification.

4. The method of claim 3, wherein creating the model based on the set of the IVR transcripts of historical customer communications further comprises:
creating a second training set by:
inputting the first training set to a second model;
extracting, by the second model, one or more sub-classifications for each of the IVR transcripts in the first training set; and
causing the second model to associate each of the IVR transcripts in the first training set with the one or more sub-classifications to create the second training set; and
creating, by a third model, the multiple embedding vectors from the second training set.

5. The method of claim 4,
wherein the first embedding vector is created based on a fourth model, and
the method further comprises training the fourth model by:
inputting, to the fourth model, the multiple embedding vectors from the second training set,
wherein each of the multiple embedding vectors includes a numerical representation of natural language extracted from the IVR transcripts and associated intent classification and one or more associated sub-classifications; and
training the fourth model to create embedding vectors based on natural language input.

6. The method of claim 1, wherein comparing the first embedding vector to the multiple embedding vectors stored in the vector database comprises:
determining cosine distances between the first embedding vector and the multiple embedding vectors,
wherein the cosine distances represent similarities between the first embedding vector and the multiple embedding vectors.

7. The method of claim 1,
wherein the intent classifications include an intent related to network operation, an intent related to marketing, an intent related to billing, or an intent related to customer accounts.

8. The method of claim 1,
wherein each intent classification includes two or more sub-classifications,
wherein each of the multiple embedding vectors is further associated with a sub-classification of the two or more sub-classifications, and
wherein the method further includes identifying which intent sub-classification of the multiple intent sub-classifications is associated with the first embedding vector.

9. The method of claim 1,
wherein the communication is received by a customer service representative or a chatbot.

10. The method of claim 1, further comprising:
in an instance that the communication includes oral communication, creating, by natural language processing (NLP), a transcript of the communication comprising the natural language.

11. The method of claim 1,
wherein creating the first embedding vector includes parsing the natural language of the communication into a sequence of text segments, and
converting the sequence of text segments into the numerical representation of the natural language used for creating the first embedding vector.

12. A computer-implemented method for classifying customer communications with a telecommunications network service provider based on customer intent, the method comprising:
receiving, by a server system associated with the telecommunications network service provider during a chatbot session, a communication from a customer associated with the telecommunications network,
wherein the communication includes natural language, and
wherein the chatbot session is between the customer and a chatbot software application configured to generate natural language in response to communications received from customers;
creating, by the server system, a first embedding vector based on the natural language of the communication,
wherein the first embedding vector includes a numerical representation of natural language extracted from the communication;
comparing, by the server system, the first embedding vector to multiple embedding vectors stored in a vector database associated with the server system,
wherein each of the multiple embedding vectors is associated with an intent classification of multiple intent classifications,
wherein the multiple embedding vectors are created based on a model that is configured to identify customer communication intent, and
identifying, based on the comparison, which intent classification of the multiple intent classifications is associated with the first embedding vector,
wherein the identification is performed in real-time during the communication session; and
generating, by the chatbot software application, a response to the received communication based on the identified intent classification.

13. The method of claim 12, further comprising creating the model based on a set of IVR transcripts of historical customer communications by:
creating a first training set by:
inputting the set of the IVR transcripts into a first model; and
causing the first model to associate each of the IVR transcripts in the set of IVR transcripts with a respective intent classification of the multiple intent classifications to create the first training set,
wherein the first training set includes the set of the IVR transcripts, each of the IVR transcripts associated with the respective intent classification.

14. The method of claim 13, wherein creating the model based on the set of the IVR transcripts of historical customer communications further comprises:
creating a second training set by:
inputting the first training set to a second model;
extracting, by the second model, one or more sub-classifications for each of the IVR transcripts in the first training set; and
causing the second model to associate each of the IVR transcripts in the first training set with the one or more sub-classifications to create the second training set; and
creating, by a third model, the multiple embedding vectors from the second training set.

15. The method of claim 14,
wherein the first embedding vector is created based on a fourth model, and
the method further comprises training the fourth model by:
inputting, to the fourth model, the multiple embedding vectors from the second training set,
wherein each of the multiple embedding vectors includes a numerical representation of natural language extracted from the IVR transcripts and associated intent classification and one or more associated sub-classifications; and
training the fourth model to create embedding vectors based on natural language input.

16. A system for classifying customer communications with a telecommunications network service provider based on customer intent, the system comprising:
at least one hardware processor; and
at least one non-transitory memory storing instructions, which, when executed by the at least one hardware processor, cause the system to:
receive, during a communication session, a communication from a customer associated with the telecommunications network,
wherein the communication includes natural language, and
wherein the communication session is between the customer and a customer service representative associated with the telecommunications network service provider;
create a first embedding vector based on the natural language of the communication,
wherein the first embedding vector includes a numerical representation of natural language extracted from the communication;
compare the first embedding vector to multiple embedding vectors stored in a vector database associated with the system,
wherein each of the multiple embedding vectors is associated with an intent classification of multiple intent classifications correspond to a prediction of a type of assistance available for customers, and
wherein the multiple embedding vectors are created based on a model that is configured to identify customer communication intent;
identify based on the comparison, which intent classification of the multiple intent classifications is associated with the first embedding vector; and
redirect the communication session to a sub-unit of the telecommunications network service provider based on the identified intent classification.

17. The system of claim 16, further caused to create the model based on a set of IVR transcripts of historical customer communications by:
creating a first training set by:
inputting the set of the IVR transcripts into a first model; and
causing the first model to associate each of the IVR transcripts in the set of IVR transcripts with a respective intent classification of the multiple intent classifications to create the first training set,
wherein the first training set includes the set of the IVR transcripts, each of the IVR transcripts associated with the respective intent classification.

18. The system of claim 17, further caused to create the model based on the set of the IVR transcripts of historical customer by:
creating a second training set by:
inputting the first training set to a second model;
extracting, by the second model, one or more sub-classifications for each of the IVR transcripts in the first training set; and
causing the second model to associate each of the IVR transcripts in the first training set with the one or more sub-classifications to create the second training set; and
creating, by a third model, the multiple embedding vectors from the second training set.

19. The system of claim 18,
wherein the first embedding vector is created based on a fourth model, and
the system is further caused to train the fourth model by:
inputting, to the fourth model, the multiple embedding vectors from the second training set,
wherein each of the multiple embedding vectors includes a numerical representation of natural language extracted from the IVR transcripts and associated intent classification and one or more associated sub-classifications; and
training the fourth model to create embedding vectors based on natural language input.

20. The system of claim 16, further caused to:
associate, by the server system, the customer with the sub-unit of the telecommunications network service provider based on the identified intent classification,
wherein the sub-unit of the telecommunications network service provider is associated with network operation, marketing, billing, or customer accounts.
